(19) United States
(12) Patent Application Publication
(10) Pub. No.: US 2020/0135155 A1
(43) Pub. Date: Apr. 30, 2020

(54) MULTI-CHANNEL POWER SUPPLY WITH GUITAR EFFECTOR DI CASSETTE

(71) Applicant: Mingsheng Xu, Shenzhen (CN)

(72) Inventor: Mingsheng Xu, Shenzhen (CN)

(21) Appl. No.: 16/169,987

(22) Filed: Oct. 24, 2018

(51) Int. Cl. G10H 1/00

(52) U.S. Cl. CPC G10H 1/0091; H01R 25/006; G10H 1/0008

(57) ABSTRACT

The invention discloses a multi-channel power supply with guitar effector DI cassette, comprising a shell, output ports, and a non-slip layer, with an audio amplifier interface formed at left of the shell rear end; it has reasonable structural design, high practicability and multiple output ports for powering effectors; the voltage and current thereof are varied to meet different users for voltages and current; the power supply is stable, safe, reliable; with four voltages: 5V, 9V, 12V, and 18V, compatible effectors are wider; the audio amplifier DI can be connected to mixing console through Canon seat, with jacks at both ends, one end connected to audio amplifier, the other to electric guitar; the amplifier can be connected to headphone accompaniment for performance and practice; the device comes with a USB charging port; the functions do not affect each other and effector power without noise; the non-slip layer increases the stability.

### BACKGROUND OF THE INVENTION

### 1. Field of the Invention

The invention relates to the technical field of effector power supply and in particular, to a multi-channel power supply with guitar effector DI cassette.

### 2. Description of the Related Art

An instrument effector is a device that changes the original timbre of the instrument or superposes the acoustic effect, and it can be divided into the distortion and multi-effector according to different functional effects, wherein the distortion is professional in function and the multi-effector is composed of multiple effects. Due to the variety of style and genre of pop music, every national music festivals have their own unique effector adaption methods, and the adaptation varies at different times. With the development of pop music, the selection of effectors will also change. Most musicians do not choose a long-frequency effector during actual performance; as long as certain effects are achieved, two or three effectors are often used in series, which is convenient in adjustment and simple in operation. In order to achieve better effects during practice or performance, it is usually necessary to use several effectors, and the demand for multi-channel power supplies for efficient, convenient and stable effects is also increasing.

At present, the prior electronic musical instruments such as electronic pianos, electric guitars, electric basses, etc. can be used with special instrument power supply, while each instrument has different power suppliers, thus various types of power sources are required for power supply in a concert, which causes troublesome devices carrying and installation, and high maintenance cost; improper interface connection is easy to occur, thus further causes the safety accident. Accordingly, those skilled in the art provide a multi-channel power supply with guitar effector DI cassette, so as to solve the problems set forth in the background art described above.

### SUMMARY OF THE INVENTION

The objective of the invention is to provide a multi-channel power supply with guitar effector DI cassette, so as to solve the problems set forth in the background art described above.

To achieve the above objective, the invention adopts the following technical solution:

a multi-channel power supply with guitar effector DI cassette, comprising a shell, output ports, and a non-slip layer, wherein an audio amplifier interface is formed at the left side of the rear end of the shell; the left side of the rear end of the shell is located next to the audio amplifier interface and is connected to a mixing console by screws; an accompaniment jack and a charging interface are formed at the middle portion of the rear end of the shell; an adapter jack and an electric guitar interface are formed at the right side of the rear end of the shell; a plurality of output ports are formed at the front end of the shell; a non-slip layer is formed at the lower end of the shell.

As a further solution of the invention: the number of output ports is at least ten, and the output ports are linearly and equidistantly aligned at the front end of the shell.

As an even further solution of the invention: the non-slip layer is made of rubber, and non-slip stripes are formed at the bottom end of the non-slip layer.

As an even further solution of the invention: the upper end and the left end, the upper end and the right end of the shell are connected in arc shape for transition.

As an even further solution of the invention: the shell is made of aluminum alloy.

Compared with the prior technology, the invention has the advantageous effects that:

the invention has reasonable structural design and high practicability, when working, the device has multiple output ports provided for supplying power for several effectors; the voltage and current of the multiple output ports are varied, so as to meet the demands of different users for different voltages and current, and the power supply is stable, safe, and reliable; the device has four voltages of 5V, 9V, 12V, and 18V, and the compatible effectors thereof are much wider; the audio amplifier DI can be connected to the mixing console through the Canon seat, with jacks at both ends, one end connected to the audio amplifier, the other end connected to the electric guitar; the amplifier can be connected to the headphone accompaniment, which can be used for performance and practice for users; the device comes with a USB charging port for charging; the functions of the invention do not affect each other, do not affect the power supply of the effector, do not generate noise, and the non-slip layer can increase the stability of the device.

### BRIEF DESCRIPTION OF THE DRAWINGS

FIG. 1 is the plan view illustrating the multi-channel power supply with guitar effector DI cassette.

FIG. 2 is the axonometric view illustrating the multi-channel power supply with guitar effector DI cassette.

FIG. 3 is the front view illustrating the multi-channel power supply with guitar effector DI cassette.

FIG. 4 is the rear view illustrating the multi-channel power supply with guitar effector DI cassette.

In the figures, 1 refers to the shell; 2 refers to the audio amplifier interface; 3 refers to the mixing console interface; 4 refers to the accompaniment jack; 5 refers to the charging interface; 6 refers to the adapter jack; 7 refers to the electric guitar interface; 8 refers to output ports; 9 refers to the non-slip layer.

### DETAILED DESCRIPTION OF THE PREFERRED EMBODIMENTS

The technical solutions in the embodiments of the invention are clearly and completely described in the following with reference to the accompanying drawings in the embodiments of the invention. It is obvious that the described embodiments are only a part of the embodiments of the invention, rather than all embodiments thereof. All other embodiments obtained by those of ordinary skill in the art based on the embodiments of the invention without creative efforts shall fall within the protection scope of the invention.

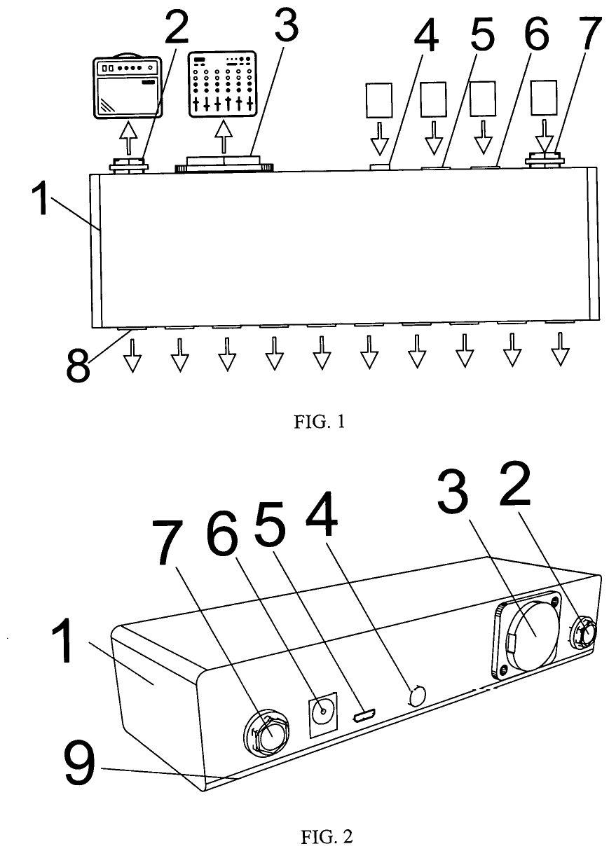

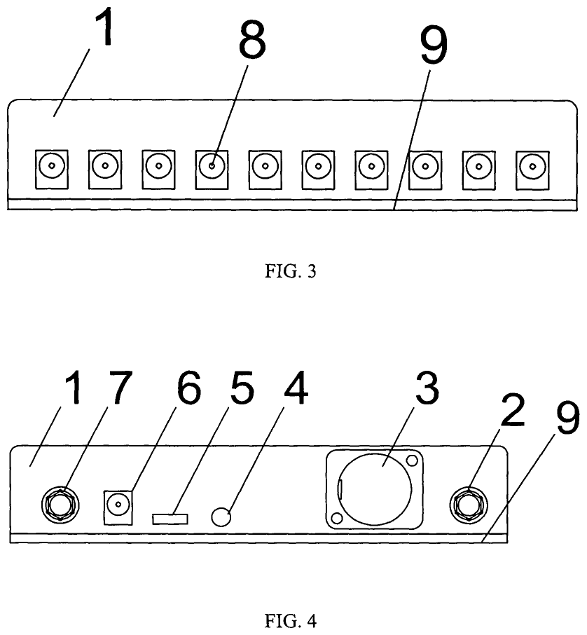

Referring to FIG. 1-4, in the embodiments of the invention, a multi-channel power supply with guitar effector DI cassette, comprising a shell 1, output ports 8 and a non-slip layer 9, wherein an audio amplifier interface 2 is formed at the left side of the rear end of the shell 1; the left side of the rear end of the shell 1 is located next to the audio amplifier interface 2 and is connected to a mixing console interface 3 by screws; an accompaniment jack 4 and a charging interface 5 are formed at the middle portion of the rear end of the shell 1; an adapter jack 6 and an electric guitar interface 7 are formed at the right side of the rear end of the shell 1; a plurality of output ports 8 are formed at the front end of the shell 1; a non-slip layer 9 is formed at the lower end of the shell 1.

The number of output ports 8 is at least ten and the output ports 8 are linearly and equidistantly aligned at the front end of the shell 1.

The non-slip layer 9 is made of rubber and non-slip stripes are formed at the bottom end of the non-slip layer 9.

The upper end and the left end, the upper end and the right end of the shell 1 are connected in arc shape for transition.

The shell 1 is made of aluminum alloy.

The operating principle of the invention is:

the invention relates to a multi-channel power supply with guitar effector DI cassette, when working, the device has multiple output ports 8 provided for supplying power for several effectors; the voltage and current of the multiple output ports 8 are varied, so as to meet the demands of different users for different voltages and current, and the power supply is stable, safe, and reliable; the device has four voltages of 5V, 9V, 12V, and 18V, and the compatible effectors thereof are much wider; the audio amplifier DI can be connected to the mixing console through the Canon seat, with jacks at both ends, one end connected to the audio amplifier, the other end connected to the electric guitar; the amplifier can be connected to the headphone accompaniment, which can be used for performance and practice for users; the device comes with a USB charging port for charging; the functions of the invention do not affect each other, do not affect the power supply of the effector, do not generate noise, and the non-slip layer 9 can increase the stability of the device, the aluminum alloy shell 1 makes the device lighter and more durable.

The invention has reasonable structural design and high practicability, when working, the device has multiple output ports provided for supplying power for several effectors; the voltage and current of the multiple output ports are varied, so as to meet the demands of different users for different voltages and current, and the power supply is stable, safe, and reliable; the device has four voltages of 5V, 9V, 12V, and 18V, and the compatible effectors thereof are much wider; the audio amplifier DI can be connected to the mixing console through the Canon seat, with jacks at both ends, one end connected to the audio amplifier, the other end connected to the electric guitar; the amplifier can be connected to the headphone accompaniment, which can be used for performance and practice for users; the device comes with a USB charging port for charging; the functions of the invention do not affect each other, do not affect the power supply of the effector, do not generate noise, and the non-slip layer can increase the stability of the device, the aluminum alloy shell makes the device lighter and more durable.

It is obvious to those skilled in the art that the invention is not limited to the details of the above-described exemplary embodiments, and the invention can be realized in other specific forms without departing from the spirit or essential characteristics of the invention. Therefore, no matter from which point of view, the embodiments shall be considered as illustrative and non-restrictive. The protection scope of the invention is defined by the appended claims rather than the descriptions above, thus all modifications that fall within the meaning and range of equivalents of the claims are included within the invention. Any reference numerals in the claims shall not be considered as limiting the involved claims.

In addition, it should be understood that although the specification is described in terms of embodiments, every embodiment does not include only one independent technical solution. The description of the specification is merely for the sake of clarity, and those skilled in the art should consider the specification as a whole. The technical solutions in various embodiments may also be combined appropriately to form other embodiments that can be understood by those skilled in the art.

1. A multi-channel power supply with guitar effector DI cassette, comprising: a shell, output ports, and a non-slip layer, wherein an audio amplifier interface is formed at the left side of the rear end of the shell; the left side of the rear end of the shell is located next to the audio amplifier interface and is connected to a mixing console interface by screws; an accompaniment jack and a charging interface are formed at the middle portion of the rear end of the shell; an adapter jack and an electric guitar interface are formed at the right side of the rear end of the shell; a plurality of output ports are formed at the front end of the shell; a non-slip layer is formed at the lower end of the shell and
a plurality of voltages, wherein the plurality of voltages are provided to the output ports to meet demands of different voltages and current.

2. The multi-channel power supply with guitar effector DI cassette according to claim 1, wherein the number of output ports is at least ten, and the output ports (8) are linearly and equidistantly aligned at the front end of the shell (1).

3. The multi-channel power supply with guitar effector DI cassette according to claim 1, wherein the non-slip layer is made of rubber, and non-slip stripes are formed at the bottom end of the non-slip layer.

4. The multi-channel power supply with guitar effector DI cassette according to claim 1, wherein the upper end and the left end, the upper end and the right end of the shell are connected in arc shape for transition.

5. The multi-channel power supply with guitar effector DI cassette according to claim 1, wherein the shell is made of aluminum alloy.
